(19) United States
(12) Patent Application Publication
(10) Pub. No.: US 2020/0051010 A1
(43) Pub. Date: Feb. 13, 2020

(54) MODIFYING TRADING PLANS DURING TRANSIT OF A CONVEYANCE

(71) Applicant: INTERNATIONAL BUSINESS MACHINES CORPORATION, ARMONK, NY (US)

(72) Inventors: Gopal K. Bhageria, Kolkata (IN); Sarbajit K. Rakshit, Kolkata (IN); Siddarth K. Saraya, Raniganj (IN)

(21) Appl. No.: 16/101,378

(22) Filed: Aug. 10, 2018

(51) Int. Cl. G06Q 10/08; G06Q 50/28

(52) U.S. Cl. CPC G06Q 10/0832; G06Q 50/28; G06Q 10/0833

(57) ABSTRACT

A method of modifying trading plans during transit of a conveyance including transiting goods on a conveyance from a shipping location to a destination location; responsive to a change in circumstances that will cause a delay in arrival of the conveyance to the destination location, searching for an alternative destination location to deliver the goods and searching by the processor for a buyer to purchase the goods for delivery at the alternative destination location; connecting to a blockchain; creating a new block for a purchase agreement that provides for the purchase of at least a portion of the goods by the buyer; and appending the new block having the purchase agreement to the blockchain.

### BACKGROUND

The present exemplary embodiments pertain to shipments of goods and, more particularly, pertain to shipments of goods that may get delayed during transit causing the consignor, shipper or consignee of the goods to modify trading plans to accommodate the transit delay.

For commercial shipping of goods, an owner of the goods may consign the goods to a shipper who may perform the actual physical task of transporting the goods from a beginning location, perhaps at the owner's warehouse or factory, to a destination location where a consignee may take possession of the goods. The method of shipping may be by, for example, truck or rail over land or by ship over water. There may also be a combination of methods of shipping such as by truck to a ship and then by ship the rest of the way. The owner of the goods may also be referred to as a consignor.

As one example, shipping of goods, also referred to interchangeably as cargo, by ship may present certain difficulties.

As cargo travels by ship, an optimized route plan may be made. The route plan may be made with multiple pieces in consideration as beginning location, destination location, time frame for delivery of the cargo and legal stops in between the beginning and destination locations for refueling and/or unloading and loading of cargo.

When the route plan is prepared, the consignor may be informed of the tentative time of delivery. This delivery time may have a bit of a buffer added to ensure that the cargo is delivered on time. But sometimes due to natural calamities, the ships cannot follow the route and may get delayed. For those cases where there may be a delay, a clause may be added by the consignor or consignee (for example, the buyer of the cargo) that if the goods do not reach the destination on time, then the shipper may need to pay a penalty. The penalty amount may vary based on the goods, consignor, consignee and the contract. In those cases where the goods are perishable or can only be sold during a particular time window, a delay in shipping may cause essentially a total loss to the consignor and/or consignee.

### BRIEF SUMMARY

The various advantages and purposes of the exemplary embodiments as described above and hereafter are achieved by providing, according to an aspect of the exemplary embodiments, a computer-implemented method of modifying trading plans during transit of a conveyance comprising: transiting goods on a conveyance from a shipping location to a destination location; responsive to a change in circumstances that will cause a delay in arrival of the conveyance to the destination location, searching by a processor for an alternative destination location to deliver the goods and searching by the processor for a buyer to purchase the goods for delivery at the alternative destination location; connecting by the processor to a blockchain; creating by the processor a new block for a purchase agreement that provides for the purchase of at least a portion of the goods by the buyer; and appending by the processor the new block having the purchase agreement to the blockchain.

According to another aspect of the exemplary embodiments, there is provided a computer program product for modifying trading plans during transit of a conveyance, the compute program product comprising a computer readable storage medium having program instructions embodied therewith, the program instructions executable by a processor to cause the processor to perform a method comprising: transiting goods on a conveyance from a shipping location to a destination location; responsive to a change in circumstances that will cause a delay in arrival of the conveyance to the destination location, searching by a processor for an alternative destination location to deliver the goods and searching by the processor for a buyer to purchase the goods for delivery at the alternative destination location; connecting by the processor to a blockchain; creating by the processor a new block for a purchase agreement that provides for the purchase of at least a portion of the goods by the buyer; and appending by the processor the new block having the purchase agreement to the blockchain.

According to a further aspect of the exemplary embodiments, there is provided a system for modifying trading plans during transit of a conveyance from a shipping location to a destination location comprising: a marketing information database; a non-transitory storage medium that stores instructions; and a processor that executes the instructions to perform the following functions: responsive to a change in circumstances that will cause a delay in arrival of the conveyance to the destination location, searching the marketing information database for an alternative destination location to deliver the goods to learn of nearest alternative destination locations having a market for the at least a portion of the goods and searching the marketing information database for a buyer to purchase the at least a portion of the goods for delivery at the alternative destination location to learn of buyers at the nearest alternative destination locations; connecting to a blockchain during transit; creating a new block on the blockchain during transit for a purchase agreement that provides for the purchase of at least a portion of the goods by the buyer; and appending during transit the new block having the purchase agreement to the blockchain.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a system for practicing the exemplary embodiments.

FIG. 2 illustrates a method of modifying trading plans during transit of a conveyance.

FIG. 3 illustrates a distributed peer-to-peer network which may include a plurality of supplier nodes, consigner nodes, consignee nodes and buyer nodes.

FIG. 4 illustrates an exemplary embodiment of a node which may be any of a consigner node, shipper node, consignee node or buyer node in the distributed peer-to-peer network.

FIG. 5 illustrates an exemplary embodiment of a block chain that may be maintained by the nodes in the peer-to-peer network.

FIG. 6 illustrates details of an exemplary block in the blockchain.

FIG. 7 illustrates another exemplary embodiment in which smart contracts may be utilized when there are individual transactions in addition to the purchase agreement.

### DETAILED DESCRIPTION

The exemplary embodiments pertain to a method and system for analyzing the holistic picture, suggesting alternative markets for goods that may be delayed during transit and selling the goods in the alternative markets by a blockchain mechanism. The exemplary embodiments are directed to a computer-implemented worldwide alternative trading platform for goods delayed during transit which is facilitated by a blockchain and smart contracts.

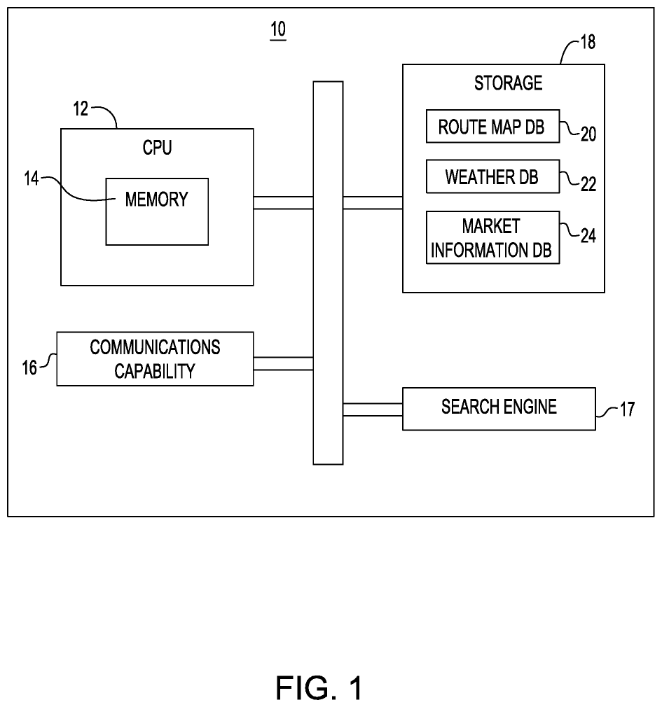

Referring to the Figures in more detail and particularly referring to FIG. 1, there is illustrated a system 10 for practicing the exemplary embodiments. System 10 may be, for example, a computing device such as a processor, laptop, tablet, desktop or server. The system 10 may be located directly on the conveyance or the conveyance may connect to the system 10 by a remote connection such as through the internet.

For purposes of illustration, the conveyance may be a truck, train, airplane or ship. For purposes of explaining the important aspects of the exemplary embodiments, the conveyance will be assumed to be a ship but it should be understood that the exemplary embodiments may apply equally as well to a truck, train or airplane as the conveyance.

System 10 may include a central processing unit (CPU) 12 having memory 14. The system 10 preferably has communications capability 16 which may include, for example, internet, WiFi, cellular and satellite communication capabilities. In the context where the system 10 is on a ship or is in communication with a ship, satellite communication capability would be particularly important.

Persistent storage 18, such as a hard disk or solid state drive, may be located within system 10 and/or remotely connected to system 10.

System 10 may additionally have databases including route mapping 20, weather 22 and market information 24. These databases may be directly located within system 10 such as stored within persistent storage 18 or may connect to these databases through communication capability 16 by applications resident within system 10. System 10 may include computer instructions to implement these databases as well as update them frequently.

The route mapping database 20 may contain maps of interest to the ship and may also store a route plan for the ship. In addition, the route mapping database 20 may be able to reroute the ship in the event of circumstances that may prevent the ship from following the stored route plan. Further included within the route mapping database 20 may be a search capability to search nearest ports having particular requirements to meet the needs of the ship or its cargo should the ship's route plan be changed.

The weather database 22 may have current weather information as well as forecasting weather capability. Too, the weather database 22 may be able to link with the route mapping database 20 to find local weather at the nearest ports should the ship's route plan be changed.

Further included may also be the market information database 24 which may include market information across the globe for a variety and types of goods sold in individual markets. The market information database 20 may be able to link with the route mapping database 20 to find markets for goods transported by the ship at the nearest ports under circumstances where the ship may be diverted.

In addition to using communications capability 16 to connect with the outside world for purposes of implementing the route mapping database 20, weather database 22 and market information database 24, communications capability 16 also may be used for general communication between the ship, the ship's owners, consignors, consignees and officials and persons at ports that the ship may have need to contact. The communications capability 16 may also be used to connect to social media via search engine 17.

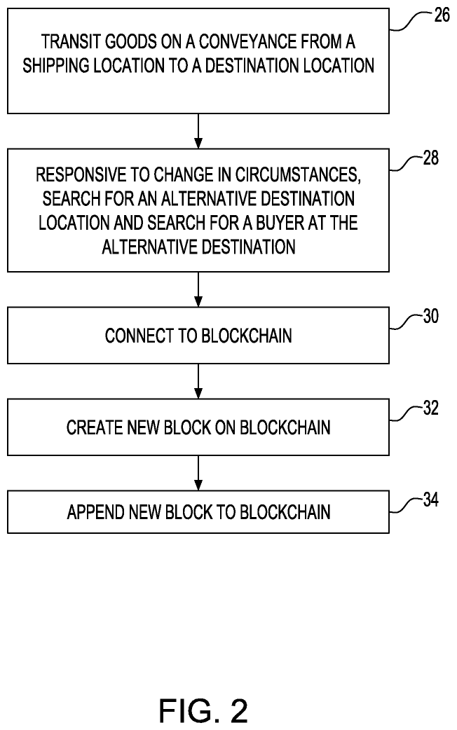

Referring now to FIG. 2, there is illustrated a method of modifying trading plans during transit of a conveyance. During transit of the ship, the ship may encounter a severe weather event, a mechanical issue with the ship, a personal emergency on the ship or any other event that may cause the ship to be delayed or perhaps even disabled. In this event, the ship may have to alter its route plan and find a near port to put in and perhaps also to sell the goods on the ship to a local buyer. The shipper may seek advice from the consigner of the goods as well as the consignee of the goods in regards to putting into a port and selling the goods.

The goods may be transited on a conveyance, such as the ship, from a shipping location to a destination location, box 26.

The ship may follow the route plan that is stored in route mapping database 20 in the system 10.

Responsive to a change in circumstances that will cause a delay in arrival of the conveyance to the destination location, an alternative destination location may be searched for to deliver the goods as well as a buyer searched for to purchase the goods for delivery at the alternative destination location, box 28.

The change in circumstances may be any event or circumstance that may cause the ship to be delayed. Examples of some of these circumstances are listed above.

For weather issues, the weather database 22 may be consulted for the latest weather conditions and forecasts of future weather conditions.

The system 10 may determine, based on the weather issue or other delaying circumstance, the delay caused by the delaying circumstance, any penalty to the shipper or other party for the delay, any decrease in valuation of the goods due to the delay. From this information, the system 10 may determine the losses from the delay.

If the loss determination is that the goods should be diverted to an alternative destination and sold to a buyer who can take delivery at the alternative destination, the system 10 may then search for alternative destinations for the goods using the route mapping database 20 and the market information database 24. These alternative destinations may be a combination of those alternative destinations nearest the ship experiencing the delay and those alternative destinations having the best markets to resell the goods to a willing buyer. The market information database 24 may even be able to find a list of buyers who may be interested in buying the goods, or a portion thereof, based on past buying behaviors of the buyers.

Alternatively, the goods may be advertised for sale on social media by the consigner, shipper and/or consignee. Social media may also be searched for buyers who may be interested in buying goods of the type that are present on the ship.

In another exemplary embodiment, the consigner, shipper and/or consignee may also have a web page specifically directed to selling goods to buyers that are for sale because of shipping delays. Buyers may regularly access the web page and search for goods that are of interest to the buyer and are subject to delivery at a destination that is acceptable to the buyer.

If a buyer is found for the goods, or at least a portion of the goods, a purchase agreement may be entered into with the buyer to consummate the transaction.

The exemplary embodiments prefer using a blockchain to consummate the transaction with the buyer. Either of the consignor, shipper and/or consignee may be the contracting party with the buyer. In this regard, it is necessary to connect to a blockchain, box 30.

A new block is created on the blockchain for a purchase agreement that provides for the purchase of at least a portion of the goods by the buyer, box 32.

The new block having the purchase agreement is appended to the blockchain, box 34.

A blockchain is a continuously growing list of records, called blocks, which are linked and secured using cryptography. Each block contains typically a hash pointer as a link to a previous block, a timestamp and transaction data. By design, blockchains are inherently resistant to modification of the data. Functionally, a blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks and a collusion of the network majority.

Blockchains are secure by design.

The first distributed blockchain was conceptualised by Satoshi Nakamoto in 2008 and implemented the following year as a core component of the digital currency bitcoin, where it serves as the public ledger for all transactions. The invention of the blockchain for bitcoin made it the first digital currency to solve the double spending problem, without the use of a trusted authority or central server.

Smart contracts represent a next step in the progression of blockchains from a financial transaction protocol to an all-purpose utility. They are pieces of software, not contracts in the legal sense, that extend blockchains' utility from simply keeping a record of financial transaction entries to automatically implementing terms of multiparty agreements. Smart contracts are executed by a computer network that uses consensus protocols to agree upon the sequence of actions resulting from the contract's code. The result is a method by which parties can agree upon terms and trust that they will be executed automatically, with reduced risk of error or manipulation.

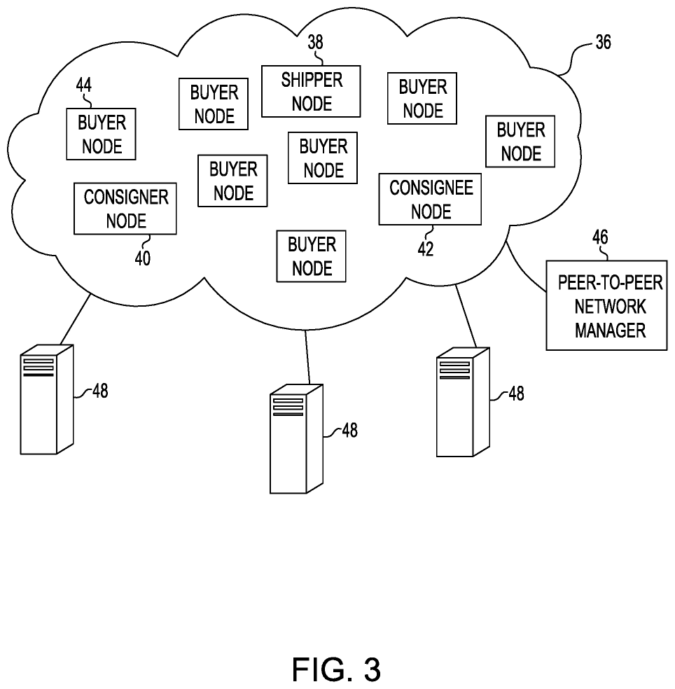

FIG. 3 illustrates a distributed peer-to-peer network 36 which may include one or more shipper nodes 38, one or more consigner nodes 40, one or more consignee nodes 42 and a plurality of buyer nodes 44. The peer-to-peer network 36 represents a computing environment for operating a decentralized framework that maintains a distributed data structure, which may be referred to herein as a secure distributed transaction ledger or a blockchain.

The peer-to-peer network 36 as illustrated in one embodiment may contain only the shipper node 38, the consigner node 40, the consignee node 42 pertaining to the shipper, with the consigner and consignee having a stake in the current goods carried by the conveyance plus a plurality of buyer nodes 44 representing a universe of buyers who might be interested in the goods. In another exemplary embodiment, the peer-to-peer network 36 may be open to all consigners, shippers, consignees and buyers so as to facilitate transactions of interest to the parties over a wide range of goods, geographic locations and circumstances.

The peer-to-peer network 36 may be managed by a peer-to-peer network manager 46 who may be a third party other than a consigner, shipper, consignee or buyer.

The peer-to-peer network 36 may be accessed by computing devices 48 of consigners, shippers, consignees and buyers.

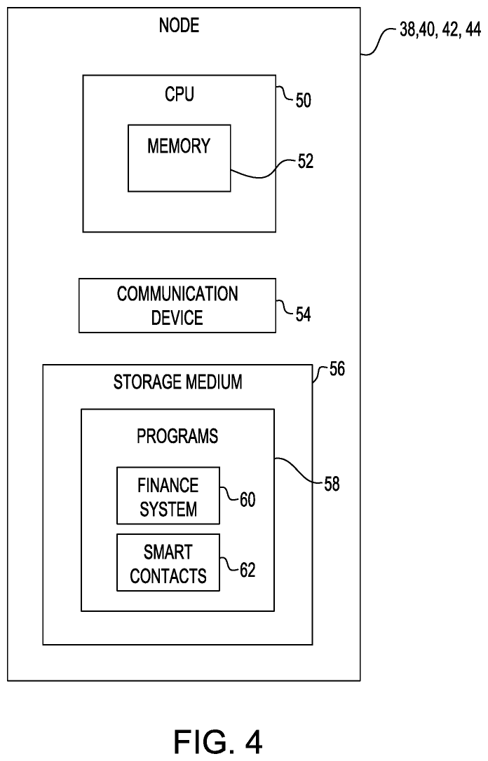

Referring now FIG. 4, there is illustrated an exemplary embodiment of a node which may be any of a consigner node 40, shipper node 38, consignee node 42 or buyer node 44 in the distributed peer-to-peer network 36. The node 38, 40, 42, 44 may include a central processing unit (CPU) 50 and memory 52. There may also be a communication device 54 for communicating with other nodes as well as communicating with computing devices 48. The node 38, 40, 42, 44 may further include a storage medium 56 which may be physically located within the node 38, 40, 42, 44 or remotely accessible by the node 38, 40, 42, 44. Within storage medium 56, or accessible by storage medium 56, may be programs 58 including but not limited to a finance system program 60 and a smart contracts program 62. Programs 58 may alternatively be within a computing device 48 external to the peer-to-peer network 36. Finance system 60, in one exemplary embodiment, may be a contract management system to handle purchase agreements and transaction agreements between the parties involved in the purchase and sale of goods.

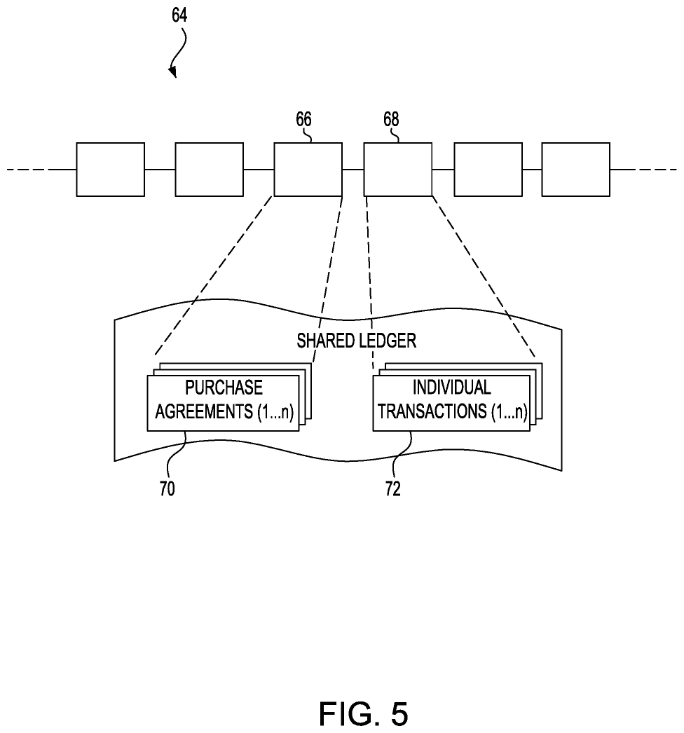

FIG. 5 illustrates an exemplary embodiment of a block chain 64 that may be maintained by the nodes in the peer-to-peer network 36. Blocks of the blockchain 64 may include one or more blocks 66 which may contain one or more purchase agreements 70.

In one exemplary embodiment, the parties may sign a purchase agreement 70 for the sale of at least a portion of the goods to a buyer. It may be that the transfer of the goods that are sold may actually occur in more than one transaction. So while the purchase agreement contains terms and conditions to govern the purchase of the goods by the buyer, each transaction of a transfer of a portion of the goods to the buyer may need to be memorialized in a separate transaction agreement. In this situation, there may be one or more blocks 68 which may contain one or more individual transactions 72.

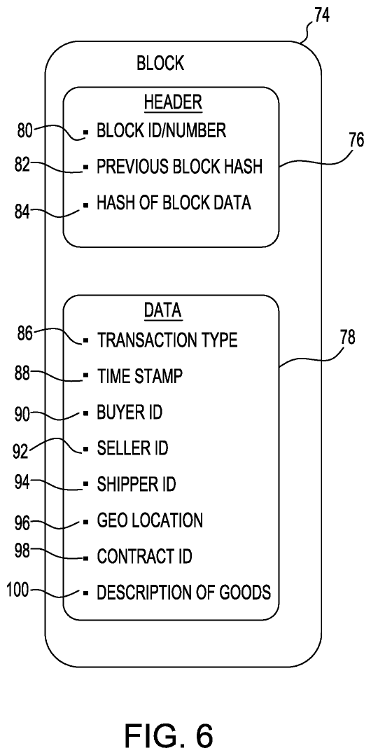

Referring now to FIG. 6, details of an exemplary block 74 in the blockchain 64 are illustrated. The exemplary block 74 is representative of the purchase agreement block 70 and individual transaction block 72 illustrated in FIG. 5. These details are for illustration only and not limitation and other blocks in the blockchain may have different details.

The exemplary block may be divided into a header section 76 and a data section 78. The header section 76 may include a Block Id/Number 80 which is a block unique identifier in the block chain, a Previous Block Hash 82 which is a hash value of the previous block for historical traceability of the block and a Hash of Block Data 84 which is a hash value of block data.

The data section 78 may include a Transaction Type 86 which is the type of transaction the block represents, for example, the purchase agreement or the individual transaction. The Time Stamp 88 is a time stamp when the block is committed to the block chain. The Buyer Id 90 is a unique Identifier for the buyer while the Seller Id 92 is a unique identifier for the seller which may be the consigner, shipper or consignee. The Shipper ID 94 is a unique identifier for the shipper of the goods. If the shipper and seller are the same entities, then the Seller ID and Shipper ID may also be the same. The Geo Location 96 is the current geographic location of the goods. The Contract Id 98 is a contract identifier as referred to in the purchase agreement between the buyer and seller. The data section 78 may also contain a Description of Goods 100 that is a description of the goods to be sold.

In one exemplary embodiment, the information in the data section 78 may be private and available only to parties authorized to view it, such as the buyer, consigner, consignee and shipper.

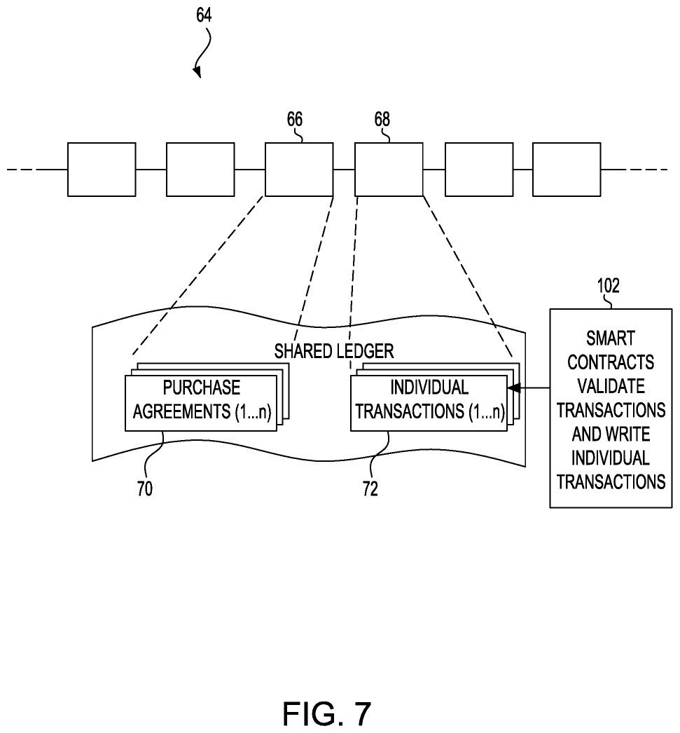

Referring now to FIG. 7, illustrated is another exemplary embodiment in which smart contracts may be utilized to facilitate the sale of goods between the buyer and the consigner, consignee or shipper.

Smart contracts may validate the individual transactions when a consigner, consignee or shipper sells a buyer a portion or all of the goods with respect to the purchase agreement block 66 and may write the transaction as an individual transaction block 68 in the secure distributed transaction ledger, box 102. This individual transaction block 68 may be written/triggered by a payment settlement routine after each individual transfer of goods occurs.

Smart contracts are software program modules within the blockchain technical framework that enable the participant buyer nodes to create transactions as blocks to the blockchain and read or query the blockchain. Additionally, the smart contracts can, based on their ability to query the blockchain, validate if a transaction is legitimate to be added as a block to the blockchain. That is, before adding an individual transaction block, the smart contracts can validate if there is a valid purchase agreement block available in the blockchain for a quantity of goods and that the requirements of the smart contract have been met. Once the requirements of the smart contract have been met, the smart contract is auto executed and the transaction is added to the blockchain.

In one exemplary embodiment, smart contracts may be set up based on a set of rules. For example, a scenario analysis may be done to design the rules. For example, if the ship cannot reach its final destination within the allotted shipping time, then the shipper, consignor or consignee may explore the option of identifying a set of buyers who would provide the best price given that the set of rules are met. These rules may be defined by the shipper, consignor or consignee based on multiple different scenarios and make it a part of the smart contract.

The smart contracts are not tied to buyer-seller purchase agreements as smart contracts are a blockchain technical platform program deployed in all nodes to work across all buyer-seller purchase agreements and individual transactions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A computer-implemented method of modifying trading plans during transit of a conveyance comprising:
transiting goods on a conveyance from a shipping location to a destination location;
responsive to a change in circumstances that will cause a delay in arrival of the conveyance to the destination location, searching by a processor for an alternative destination location to deliver the goods and searching by the processor for a buyer to purchase the goods for delivery at the alternative destination location;
connecting by the processor to a blockchain;
creating by the processor a new block for a purchase agreement that provides for the purchase of at least a portion of the goods by the buyer; and
appending by the processor the new block having the purchase agreement to the blockchain.

2. The method of claim 1 wherein responsive to a transaction of supplying a quantity of the at least a portion of the goods to the buyer, further comprising appending by the processor the transaction as a block to the blockchain.

3. The method of claim 2 wherein appending the transaction comprising validating the transaction by a smart contract within a framework of the blockchain and writing the transaction as a block to the blockchain.

4. The method of claim 1 wherein searching for the alternative destination location comprising accessing by the processor a database having marketing information to learn of nearest alternative destination locations having a market for the at least a portion of the goods.

5. The method of claim 4 wherein searching for the buyer comprising accessing by the processor the database to learn of buyers at the nearest alternative destination locations.

6. The method of claim 5 wherein searching for the buyer further including advertising on social media.

7. The method of claim 1 further comprising establishing by the processor a website accessible to potential buyers listing the goods and nearest alternative destination locations.

8. The method claim 1 wherein the conveyance is a ship.

9. A computer program product for modifying trading plans during transit of a conveyance, the compute program product comprising a computer readable storage medium having program instructions embodied therewith, the program instructions executable by a processor to cause the processor to perform a method comprising :
transiting goods on a conveyance from a shipping location to a destination location;
responsive to a change in circumstances that will cause a delay in arrival of the conveyance to the destination location, searching by a processor for an alternative destination location to deliver the goods and searching by the processor for a buyer to purchase the goods for delivery at the alternative destination location;
connecting by the processor to a blockchain;
creating by the processor a new block for a purchase agreement that provides for the purchase of at least a portion of the goods by the buyer; and
appending by the processor the new block having the purchase agreement to the blockchain.

10. The computer program product of claim 9 wherein responsive to a transaction of supplying a quantity of the at least a portion of the goods to the buyer, further comprising appending by the processor the transaction as a block to the blockchain.

11. The computer program product of claim 10 wherein appending the transaction comprising validating the transaction by a smart contract within a framework of the blockchain and writing the transaction as a block to the blockchain.

12. The computer program product of claim 9 wherein searching for the alternative destination location comprising accessing by the processor a database having marketing information to learn of nearest alternative destination locations having a market for the at least a portion of the goods.

13. The computer program product of claim 12 wherein searching for the buyer comprising accessing by the processor the database to learn of buyers at the nearest alternative destination locations.

14. The computer program product of claim 13 wherein searching for the buyer further including advertising on social media.

15. The computer program product of claim 9 further comprising establishing by the processor a website accessible to potential buyers listing the goods and nearest alternative destination locations.

16. The computer program product of claim 9 wherein the conveyance is a ship.

17. A system for modifying trading plans during transit of a conveyance from a shipping location to a destination location comprising:
a marketing information database;
a non-transitory storage medium that stores instructions; and
a processor that executes the instructions to perform the following functions:
responsive to a change in circumstances that will cause a delay in arrival of the conveyance to the destination location, searching the marketing information database for an alternative destination location to deliver the goods to learn of nearest alternative destination locations having a market for the at least a portion of the goods and searching the marketing information database for a buyer to purchase the at least a portion of the goods for delivery at the alternative destination location to learn of buyers at the nearest alternative destination locations;
connecting to a blockchain during transit;
creating a new block on the blockchain during transit for a purchase agreement that provides for the purchase of at least a portion of the goods by the buyer; and
appending during transit the new block having the purchase agreement to the blockchain.

18. The system of claim 17 wherein responsive to a transaction of supplying a quantity of the at least a portion of the goods to the buyer, further comprising appending by the processor the transaction as a block to the blockchain.

19. The system of claim 18 wherein appending the transaction comprising validating the transaction by a smart contract within a framework of the blockchain and writing the transaction as a block to the blockchain.

20. The system of claim 17 further comprising establishing by the processor a website accessible to potential buyers listing the goods and nearest alternative destination locations.
